(19) United States
(12) Patent Application Publication
(10) Pub. No.: US 2026/0080453 A1
(43) Pub. Date: Mar. 19, 2026

(54) SYSTEM AND METHOD FOR A REAL-TIME EGOCENTRIC COLLABORATIVE FILTER ON LARGE DATASETS

(71) Applicant: Xerox Corporation, Webster, NY (US)

(72) Inventors: Eric Huang, San Francisco, CA (US); Rong Zhou, San Jose, CA (US)

(21) Appl. No.: 19/395,274

(22) Filed: Nov. 20, 2025

Related U.S. Application Data
(63) Continuation of application No. 17/871,285, filed on Jul. 22, 2022, now Pat. No. 12,505,478.
Application No. 17/871,285 is a continuation of application No. 15/074,922, filed on Mar. 18, 2016, now Pat. No. 11,436,656.

(51) Int. Cl. G06Q 30/0601

(52) U.S. Cl. CPC G06Q 30/0631; G06Q 30/0643

(57) ABSTRACT

One embodiment of the present invention provides a system for generating a product recommendation. During operation, the system obtains data indicating vertices and edges of a graph. The vertices represent consumers and products and an edge represents an access relationship. The system may receive a query indicating an ego for determining a product recommendation. The system may then traverse the graph from a vertex representing the ego through a plurality of edges to a plurality of vertices representing products. The system may traverse the graph from the plurality of vertices representing products to a plurality of vertices representing other consumers. The system may then traverse the graph from the plurality of vertices representing other consumers to a plurality of vertices representing other products. The system may generate a recommendation that based on the plurality of vertices representing other products.

The present disclosure is related to U.S. patent application Ser. No. 13/932,377, (Attorney Docket Number PARC-20130011-US-NP), titled “System and Method for Parallel Search on Explicitly Represented Graphs,” by inventor Rong Zhou, filed 1 Jul. 2013, the disclosure of which is hereby incorporated by reference herein.

The present disclosure is related to U.S. patent application Ser. No. 14/148,435, (Attorney Docket Number PARC-20130013-US-NP), titled “Automated Compilation Of Graph Input For The Hipergraph Solver,” by inventors Eric Huang, Rong Zhou and Daniel Davies, filed 6 Jan. 2014, the disclosure of which is hereby incorporated by reference herein.

The present disclosure is related to U.S. patent application Ser. No. 14/039,941, (Attorney Docket Number PARC-20130118-US-NP), titled “System And Method For A High-Performance Graph Analytics Engine,” by inventors Rong Zhou and Daniel Davies, filed 27 Sep. 2013, the disclosure of which is hereby incorporated by reference herein.

### BACKGROUND

### Field

The present disclosure relates to recommendation systems. More specifically, this disclosure relates to a method and system for real-time egocentric collaborative filtering on large datasets using Hipergraph.

### Related Art

HiperGraph is a stand-alone graph solver that performs analytics techniques on graph-based representation of data. Its strengths over a standard database lie in the characterization of computations as graph traversals instead of traditional, computationally-intensive relational database joins. HiperGraph specializes in graph reasoning and enables new real-time applications on a much larger volume of data for graph-based computations.

FIG. 1 presents a block diagram 100 illustrating an example of a database schema in a multimedia domain, and a corresponding example of how data may be represented in a graph model. The database in FIG. 1 has three tables. The first table 102 has “Accessed ID” as its primary key, and contains a set of rows, each representing a transaction where a particular consumer has accessed a particular piece of media content. The second table 104 has “Consumer ID” as its primary key, and each row represents a unique consumer along with its metadata. The third table 106 has “Media ID” as its primary key, and each row represents a unique digital asset along with its metadata.

The graph model 108 corresponding to this database schema has vertices representing consumers and media, and edges representing media accesses. The question presented in this example is “what new media should we recommend to a consumer based on his or her friends?” Here, a friend is defined as another consumer who has accessed at least one piece of content in common in the past.

In many cases similar to this domain, the underlying database tables may be constantly changing as additional access activities are added, implying changes to the graph itself. The changing nature of the data necessitates recomputing the same query in order to provide a time-relevant answer, and therefore performance is critical. For example, if a website dynamically provides recommendations, the website may need to respond to queries within seconds in real-time. Moreover, the fact that a server may need to answer queries from many users simultaneously interacting with the website further complicates the problem.

### SUMMARY

One embodiment of the present invention provides a system for generating a product recommendation. During operation, the system obtains graph data indicating vertices and edges of a graph. The vertices represent consumers and products and an edge represents an access relationship. The system may receive a query to determine a product recommendation. The query indicates an ego for determining a product recommendation. The system may then traverse the graph from a vertex representing the ego through a plurality of edges to a plurality of vertices representing products. The system may traverse the graph from the plurality of vertices representing products to a plurality of vertices representing other consumers. The system may then traverse the graph from the plurality of vertices representing other consumers to a plurality of vertices representing other products. The system may generate a recommendation that based on the plurality of vertices representing other products.

In a variation on this embodiment, the system may generate the graph based on data from one or more database tables, and stream the graph from a Structured Query Language (SQL) database over a network to an executing application.

In a variation on this embodiment, the system may receive command-line parameters indicating a number of starting vertices, a number of recommendations to be generated, a number of traversals, or a number of media that must be shared in common between the ego and another consumer.

In a variation on this embodiment, the system may receive a second query to determine product recommendations for a plurality of egos. The system may then traverse, by a plurality of processors operating in parallel, the graph from the plurality of egos through a plurality of edges to a plurality of vertices representing products. The system may then traverse, by the plurality of processors operating in parallel, the graph from the plurality of vertices representing products to a plurality of vertices representing other consumers. The system may then traverse, by the plurality of processors operating in parallel, the graph from the plurality of vertices representing other consumers to a plurality of vertices representing other products. The system may calculate a tally for each of the plurality of vertices representing other products. The system may then sort the plurality of vertices representing other products, and generate a recommendation based on the sorted plurality of vertices representing other products.

In a variation on this embodiment, the graph has multiple edge types connecting vertices, and one of the edge types represents a like relationship between a respective consumer and a respective product, and wherein the vertex representing the ego and the plurality of vertices representing other consumers are also connected via edges representing like relationships.

In a variation on this embodiment, the system may calculate a tally for each of the plurality of vertices representing other products.

In a further variation, the system may sort and rank the plurality of vertices representing other products, and generate the recommendation to include one of: all products associated with the plurality of vertices representing other products and their corresponding tallies, products with tallies above a predetermined ranking, and all products and their corresponding tallies in which the corresponding tallies are greater than a predetermined user-specified value.

### BRIEF DESCRIPTION OF THE FIGURES

FIG. 1 presents a block diagram illustrating an example of a database schema in a multimedia domain, and a corresponding example of how data may be represented in a graph model.

FIG. 2 presents a block diagram illustrating an exemplary architecture of an egocentric collaborative filtering system, according to an embodiment.

FIG. 3 presents an example of formatted output of the collaborative filter, according to an embodiment.

FIG. 4 presents an example of a SQL query for the egocentric collaborative filter, according to an embodiment.

FIG. 5 illustrates an overview of an exemplary egocentric collaborative filter and implementation using HiperGraph primitives, according to an embodiment.

FIG. 6 presents a block diagram illustrating five stages of a technique for egocentric collaborative filtering, according to an embodiment.

FIG. 7 presents a sequence diagram showing how HiperGraph and a SQL database communicate with one another, according to an embodiment.

FIG. 8 presents a flowchart illustrating an exemplary process for real-time egocentric collaborative filtering, according to an embodiment.

FIG. 9 presents a table illustrating a comparison of two egocentric collaborative filtering implementations HANA-only and a combination of HANA and HiperGraph.

FIG. 10 presents a table of experimental results comparing implementations of the egocentric collaborative filter on Hadoop/Hive with HiperGraph.

FIG. 11 presents a table comparing time performance between Hive and HiperGraph, with a breakdown of graph building, streaming, and HiperGraph reasoning.

FIG. 12 presents a table illustrating a general template for a class of egocentric collaborative techniques that leverage paragraph primitives, in accordance with an embodiment.

FIG. 13 presents a table illustrating how Hipergraph primitives may map to relational primitives, in accordance with an embodiment.

FIG. 14 presents a block diagram illustrating an exemplary apparatus that facilitates egocentric collaborative filtering, in accordance with an embodiment.

FIG. 15 illustrates an exemplary egocentric collaborative filtering server, in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of improving performance of a collaborative filtering process by using Hipergraph primitives to perform operations on graph data rather than relying on a Structured Query Language (SQL) database to perform equivalent operations on data in relational tables. An egocentric collaborative filtering system may generate a graph model from consumer access data stored in a database and then apply Hipergraph primitives to efficiently perform collaborative filtering. For example, the system can use Hipergraph primitives to traverse forward or backward from one set of vertices to another set of vertices in order to perform a database join. By performing the join using a graph rather than using traditional relational tables, the system can significantly speed up computations and reduce the amount of memory required.

The recommendation technique this disclosure describes is one of a class of techniques which the inventors call egocentric collaborative filters. The term egocentric refers to the property that the computations reference a specific vertex which the inventors call the “ego,” and frequently the set of graph operations that the system performs may originate from the ego. For example, the system can traverse a graph to determine media that a user (e.g., ego) accesses, and from vertices representing those media traverse the graph to determine other consumers that access the same media as the ego. The system can then traverse the graph again to determine media that the other consumers access to generate a recommendation.

The disclosure explains how a class of such techniques implemented using HiperGraph can achieve a significant boost in performance compared to standard approaches. Such performance improvements include that HiperGraph's intermediary computations when performing traversals does not significantly increase memory requirements. In contrast, for SQL databases, the intermediary computations associated with executing join operations significantly increases such memory requirements. For problem sizes of 1,000 recommendation queries or larger, experiments have demonstrated that the disclosed techniques dominate other approaches. This is seen in best-in-class comparisons to open source graph reasoning systems, an enterprise in-memory SQL server, and a Hive/Hadoop cluster.

### System Architecture

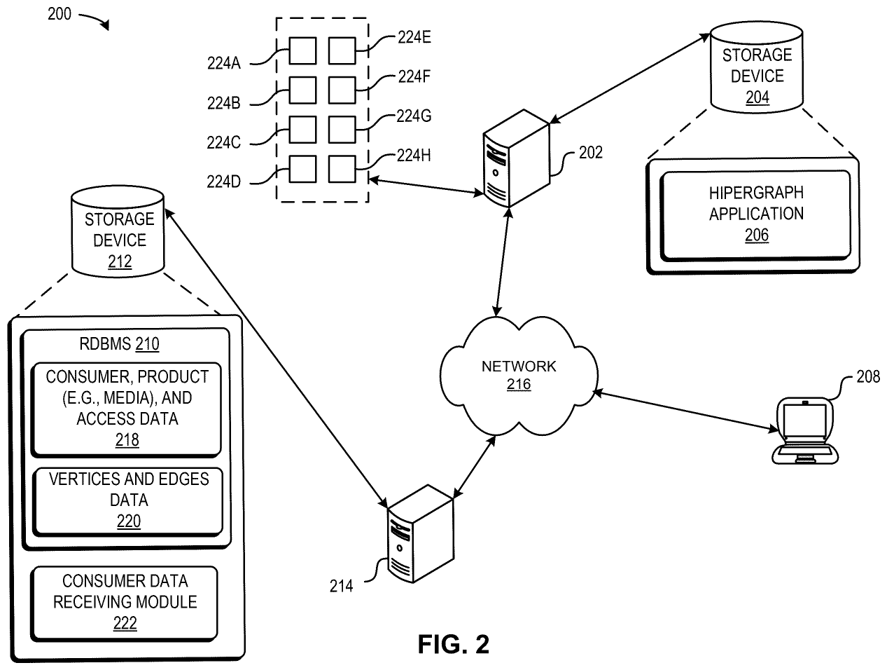

FIG. 2 presents a block diagram illustrating an exemplary architecture of an egocentric collaborative filtering system 200, according to an embodiment. System 200 may generate graphs and traverse through graphs to facilitate various applications such as collaborative filtering.

System 200 may include a Hipergraph server 202 with a storage 204. A Hipergraph application 206 may be installed on storage device 204. Hipergraph server 202 may receive a query from a client 208 (or receive a query locally on server 202). Hipergraph server 202 may receive queries that are written in a declarative language.

The query may request recommendations for one or more consumers (e.g., egos). Hipergraph application 206 may receive a graph from RDBMS 210 installed on a storage device 212 of a server 214. RDBMS 210 may stream the graph data to Hipergraph application 206 over a network 216. Note that in some embodiments, Hipergraph application 206 and RDBMS 210 may be installed on the same server and system 200 may copy the graph from one portion of the server memory to another in order to transfer graph data from RDBMS 210 to Hipergraph application 206.

System 200 may receive consumer, product (e.g., media), and access data 218, and generate vertices and edges 220. System 200 may store in storage device 212 code for a consumer data receiving module 222 that receives the consumer, product, and access data. System 200 may retrieve the program code for Hipergraph application 206 from storage device 204. Note that various implementations of the present invention may include any number of servers and storage devices.

In some implementations, Hipergraph server 202 may include a graph analytics engine or other components of egocentric collaborative filtering system 200 to perform the techniques described herein. In some implementations, system 200 may execute dynamic vertex-to-processor mapping to divide up the vertices of a graph into subranges, assign the various subranges to processors, and process the vertices using the respective processors. This improves utilization of available processors. For example, system 200 may dynamically divide the vertices and assign the vertices to processors 224A-224H, which operate on the assigned vertices.

### How is Problem Solved Today—Input and Output Description

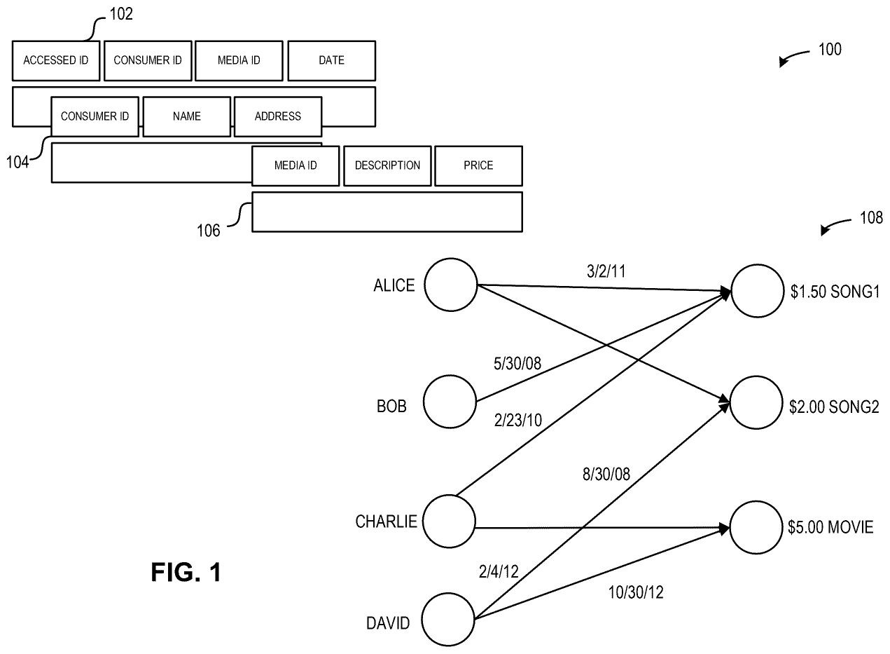

The input data is a list of egos for which the system computes recommendations, as well as the accessed table in FIG. 1. The bulk of the work performed does not need to reference the consumer or the media tables (such tables are only necessary when needing to map the ID numbers back to their human-readable names). The inventors use an actual dataset which contains on the order of tens of millions of vertices and hundreds of millions of edges that correspond to the rows of the accessed table.

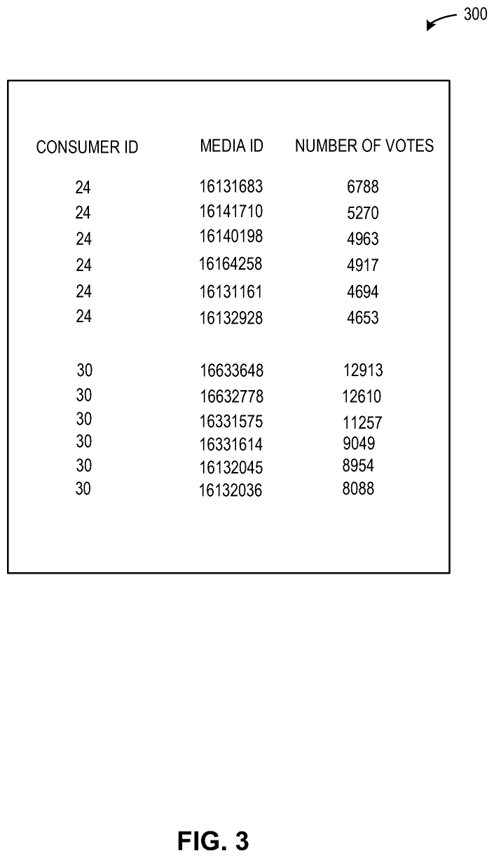

FIG. 3 presents an example 300 of formatted output of the collaborative filter, according to an embodiment. As illustrated in FIG. 3, output 300 includes rows of triples that include a consumer ID, a media ID, and a number of votes. The consumer ID column indicates for which consumer the system performs the recommendation. The media ID column indicates the item that the system recommends to the consumer, and the number of votes column indicates how many votes their friends cast for that media. This disclosure defines the ego's “friend” as other consumers who access at least one media in common with the ego. Each friend casts one vote for each media the friend accesses in common with the ego.

Note that the examples presented herein describe consumers accessing media and generating a recommendation for media, but embodiments of the present invention may generate recommendations for any type of purchased, consumed, viewed, or accessed products.

### Graph Database Comparison

Various graph-based systems currently available include Neo4j, a graph database, and GraphLab, an open-source package for machine learning. HiperGraph outperforms both of these technologies at a fine-grained primitive level. Because HiperGraph has been demonstrated to have significantly faster primitives for graph traversals, the techniques disclosed herein which make use of several such primitives chained together in series can only be faster by comparison. See U.S. patent application Ser. No. 14/039,941, entitled “System And Method For A High-Performance Graph Analytics Engine,” by inventors Rong Zhou and Daniel Davies, filed 27 Sep. 2013, which describes experimental results using Hipergraph.

### SQL Comparison

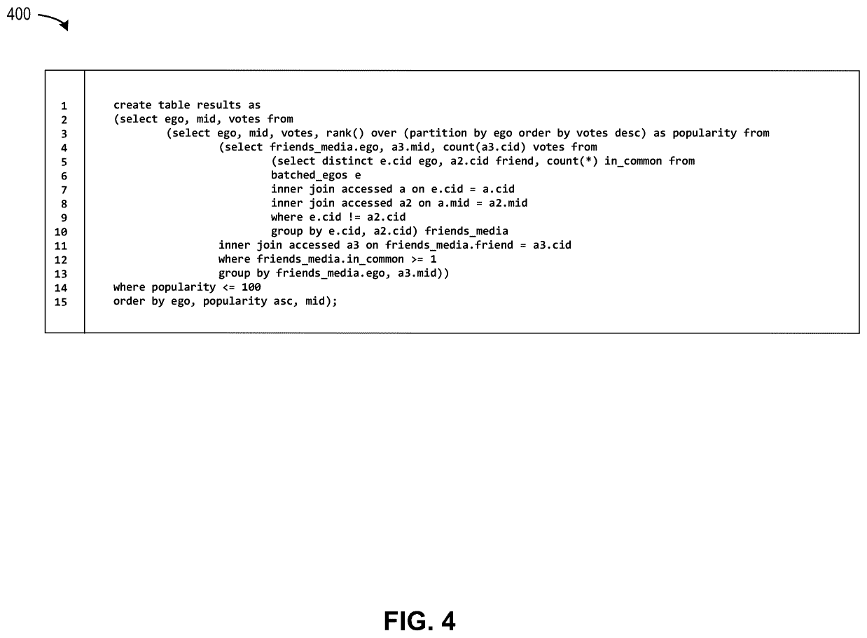

FIG. 4 presents an example 400 of a SQL query for the egocentric collaborative filter, according to an embodiment. Due to the prevalence of the relational model, data is typically stored in SQL databases and SQL can be used in a collaborative filtering implementation. The inventors compared two different SQL systems and the details are described below. Aside from minor system-specific syntax, the queries are nearly identical, and are presented in FIG. 4.

The set of egos that the system computes recommendations for is contained in table batched_egos, as seen in line 6. Table accessed is as described earlier, and all tables have column names cid representing consumer ID and pid representing media ID. Lines 6-8 join the desired set of egos with the accessed table twice, so that the system can find the set of friends that access the same media as that of the ego.

Line 9 excludes the ego from being considered a friend of him or herself. Finally, the group-by clause in line 10 computes the number of media that the ego accesses in common with each friend. Thus, lines 5-10 generate an intermediary table called friends_media which contains three columns: the ego, the friend, and the number of media accesses in common between the two.

The friends_media intermediary table is joined in line 11 with the accessed table again to find the media that might be recommended, and the group-by clause in line 13 tallies up the number of friends that vote for that media. Here, a friend who accesses a particular media is considered to cast one vote for that media. Note that the where clause in line 12 requires that the database system consider only friends who have at least one media purchase in common with the ego. Therefore, lines 4-13 generate an intermediary table of three columns: the ego, the media to recommend, and a count of the number of friends who vote for that media.

The select statement of line 3 sorts the previous results using a ranking function over the number of votes, and the entire query from lines 2-15 selects the top 100 most popular (or alternatively, most voted on) media recommendations for each ego. Line 15 sorts these recommendations in the order required for the final output.

Note that in some embodiments of the present invention, an egocentric collaborative filtering system can determine a total amount of points, stars, or other ratings measure assigned to a media or other product by consumers that are friends, and the system sorts the media or other product according to the determined total amount. The system can also assign a greater weighting to those friends that have a greater number of common media accesses with the ego, or assign a greater weighting to those friends that have a greater number of edges of different edge types in common with the ego. The system can also assign greater weighting to friends with common accesses that have occurred more recently, or assign greater weighting to those friends with a greater number of common accesses within a predetermined time period.

The system may use a batch of egos as input for computing recommendations, instead of starting with a single ego. The application must answer recommendation queries constantly, and it is highly inefficient for the SQL database to conduct multiple joins for every single ego serially. The system can achieve higher efficiency by processing the initial egos all simultaneously in a group. At some point, with a large enough ego batch size the system runs out of memory because the intermediary tables for a large accessed table exceed memory capacity. In experiments the inventors have tuned this and other parameters to give the SQL database the best performance possible while still respecting its memory constraints. For example, the inventors found that the SQL databases perform best when the entire query is expressed as a single nested statement, due to the maturity of the query optimizers.

### Exemplary Egocentric Collaborative Filter and Implementation Using Hipergraph Primitives

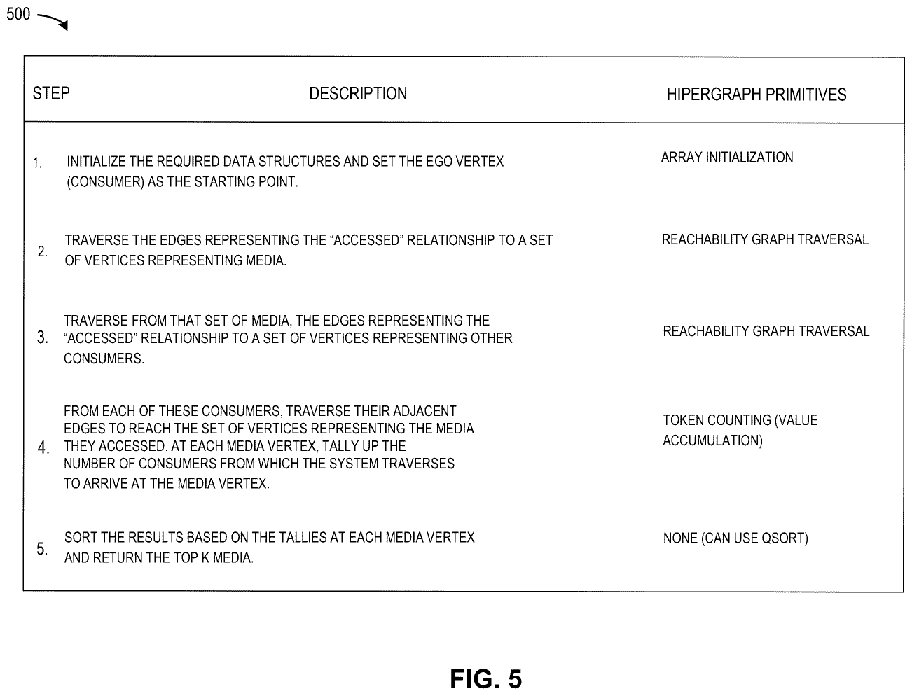

FIG. 5 illustrates an overview 500 of an exemplary egocentric collaborative filter and implementation using HiperGraph primitives, according to an embodiment. The disclosed egocentric collaborative filtering technique makes use of various HiperGraph primitive operations. The description below outlines the structure of the egocentric collaborative filter technique implemented for a specific set of parameters.

As illustrated in FIG. 5, an exemplary implementation may include initializing data structures and starting with the ego vertex. The system may traverse edges representing accessed relationships to a set of vertices representing media. The system then traverses from the set of vertices representing media, the edges representing accessed relationships to a set of vertices representing other consumers. From each of these consumers, the system traverses their adjacent edges to reach the set of vertices representing the media they accessed. At each media vertex, the system may tally up the number of consumers from which the system traverses to arrive at the media vertex. The system may then sort the results based on the tallies at each media vertex and return the top k media.

### Five Stages of a Technique for Egocentric Collaborative Filtering

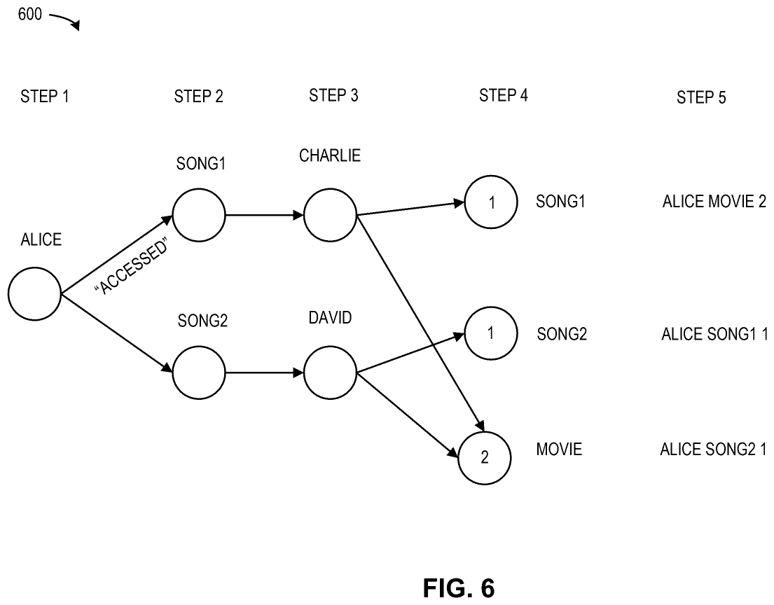

FIG. 6 presents a block diagram 600 illustrating five stages of a technique for egocentric collaborative filtering, according to an embodiment. Note that in step 4 of FIG. 6, the number of consumers voting for a given media is different from the number of consumers that access the media. The set of consumers in step 4 are those determined in step 3 that access a media in common with the ego. Also, the description above is a specific instantiation of the parameterized egocentric collaborative filter which the inventors have implemented. Specifically, one embodiment permits the user to specify the following parameters on the command-line:
The number of ego vertices for which the system will perform steps 1-5 of FIG. 6. An outer loop runs through all desired egos, and computations are logically independent from one another due to local data structures. This allows the system to compute the egos in parallel.
A set of edge types that determine the set of consumers in step 3. For example, the consumers in step 3 might alternatively be determined by the set of vertices for which the ego shares an “accessed” media in common and a “like” media in common. This requires that the input graph have multiple edge types connecting vertices together. The set of consumers generated must be connected via the media in all of the specified ways and the set of media must be connected to the ego in all of the specified ways as well.
The number of media that must be shared in common between the ego and the set of consumers computed in step 3.
The final filtering mechanism, which is one of the three following options:
   Return all media and their corresponding tallies.
   Return the top k media and their tallies, ranked in decreasing order of their tally count, where k is user-specified.
   Return all media and their corresponding tallies if their tallies are greater than a predetermined threshold value n, where n is user-specified.

### Hipergraph and SQL Database

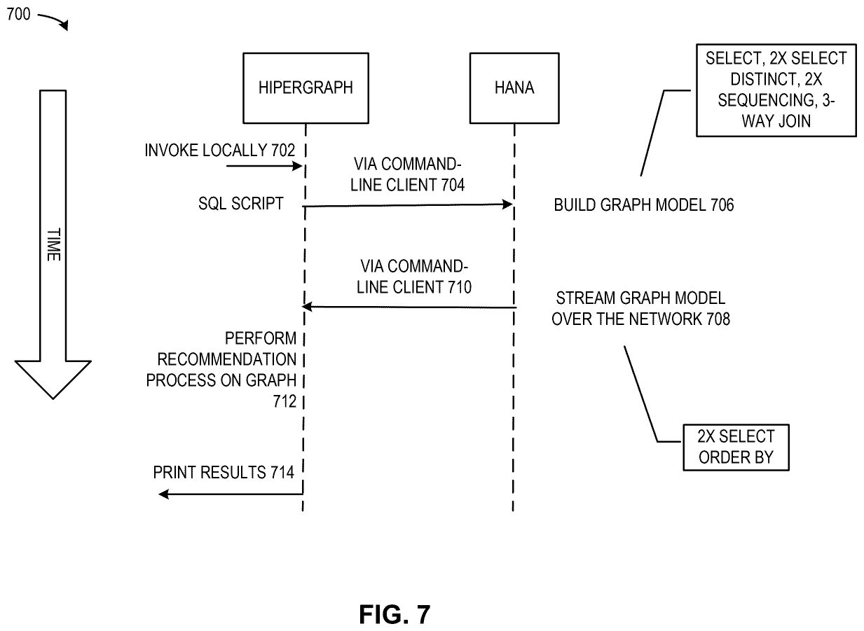

FIG. 7 presents a sequence diagram 700 showing how HiperGraph and the SQL database communicate with one another, according to an embodiment. In the figure, HANA is a specific instance of an RDBMS. Recall that HiperGraph requires a graph model in order to reason over data. Since the data is typically stored in a SQL database, one implementation involves integrating HiperGraph with the SQL database so that the graph model can be automatically generated and streamed over to HiperGraph. The architecture for integrating a RDBMS and HiperGraph is illustrated in the sequence diagram of FIG. 7.

When a media recommendation is required, the system can invoke HiperGraph (operation 702), which uses a SQL-like language and a command-line client to communicate with a SQL database (operation 704). In this case, the system uses SAP HANA, an in-memory enterprise database system, and the command-line client provided by SAP, which communicates via standard input and standard output. Experiments demonstrate that the command line client from SAP is faster than a manual ODBC connection.

Within the SQL database, the system builds the graph model (operation 706) with various calls to SQL select, sequencing, and join constructs as mentioned in U.S. patent application Ser. No. 14/148,435, entitled “Automated Compilation Of Graph Input For The Hipergraph Solver,” by inventors Eric Huang, Rong Zhou, and Daniel Davies, filed 6 Jan. 2014. After the system builds the model, the system streams the model over the network back to HiperGraph (operations 708 and 710), which then is able to perform reasoning on the graph model (operation 712) and output the results (operation 714). This example and the experiments use SAP HANA, because SAP HANA is an in-memory database representing the best-in-class for SQL servers. SAP HANA is one of the fastest, if not the fastest, enterprise in-memory SQL server available. Note that various implementations may use any SQL server, since the experimental setup leverages standard SQL interfaces and language to construct the graph model and integrate with HiperGraph. Typical enterprise RDBMSs built around disk storage will likely be significantly slower as SAP HANA has 1TB of memory and performs all computations in RAM without touching the disk. All the experiments use the exact same dataset, which has on the order of tens of millions of vertices and hundreds of millions of edges.

### Exemplary Process for Real-Time Egocentric Collaborative Filtering

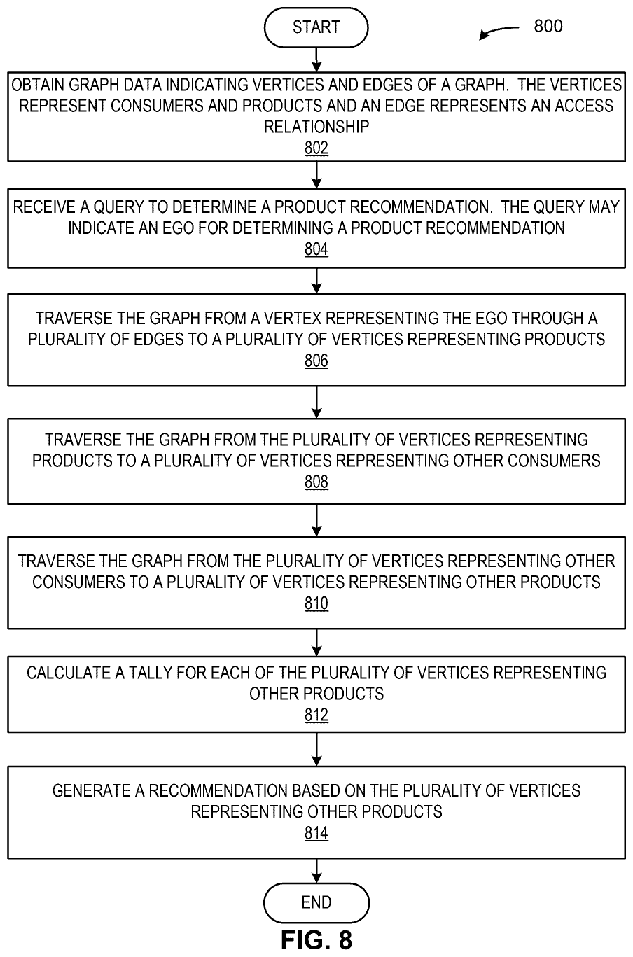

FIG. 8 presents a flowchart 800 illustrating an exemplary process for real-time egocentric collaborative filtering, according to an embodiment. During operation, system 200 obtains graph data indicating vertices and edges of a graph. The vertices represent consumers and products and an edge represents an access relationship (operation 802). The system may receive a query to determine a product recommendation. The query may indicate an ego for determining a product recommendation (operation 804). The system may then traverse the graph from a vertex representing the ego through a plurality of edges to a plurality of vertices representing products (operation 806). The system may then traverse the graph from the plurality of vertices representing products to a plurality of vertices representing other consumers (operation 808). The system subsequently traverses the graph from the plurality of vertices representing other consumers to a plurality of vertices representing other products (operation 810). The system may calculate a tally for each of the plurality of vertices representing other products (operation 812). The system may generate a recommendation based on the plurality of vertices representing other products (operation 814).

### Egocentric Collaborative Filter Using Hipergraph Performance

A relational database management system may load, reference, and modify a dataset that includes tens of millions of vertices and hundreds of millions of edges, but performing many joins on such a dataset would be infeasible. Thus, the system uses HiperGraph to compute media recommendations for “consumers who access at least one media that the queried consumer also accesses,” since the system may avoid relational joins implied by this query and perform graph traversals in HiperGraph. The result is that computing recommendations of the form of the egocentric collaborative filter using HiperGraph significantly outperforms using the traditional SQL database.

The inventors ran multiple experiments using various dataset sizes from 1 month of an accessed transaction table up to 3 years' worth of data, and also varied the number of recommendation computations from 100 egos up to 100,000 egos.

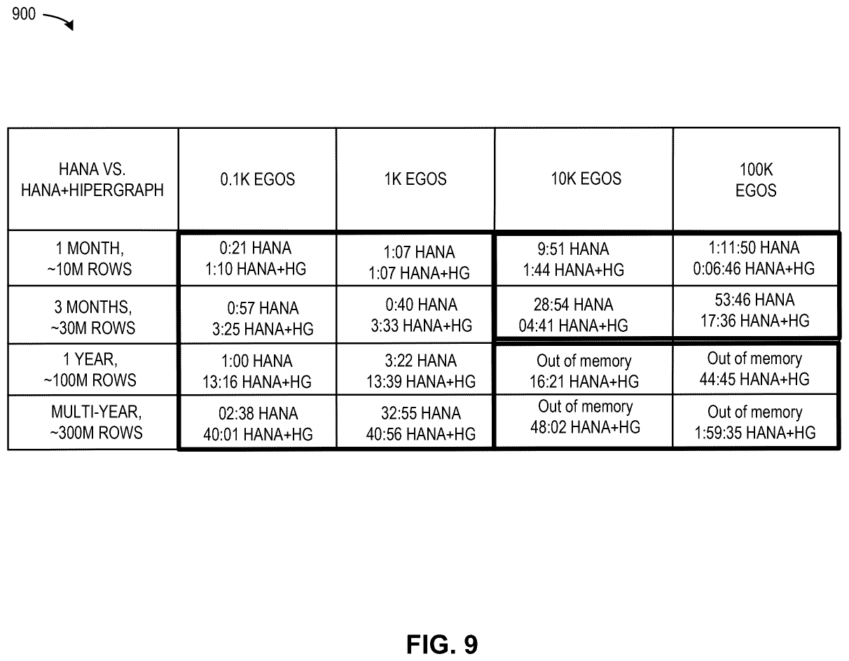

FIG. 9 presents a table illustrating a comparison of two egocentric collaborative filtering implementations HANA-only and a combination of HANA and HiperGraph. FIG. 9 shows the results of experiments. Each cell of the table compares the HANA (SQL database) example described with respect to FIG. 4 to the HANA and HiperGraph combination architecture of FIG. 7. Each cell is a different query size and dataset size. Notice that in the lower-right cells the HANA database runs out of memory because the combination of batched egos with the size of the accessed datasets causes the intermediary tables (resulting from all the joins) to exceed memory capacity. In contrast, the HANA plus Hipergraph implementation successfully computes and returns the results.

The four top right cells in the table represent cases where the HANA plus Hipergraph implementation outperforms the standard HANA installation as well. The cells in the first two results columns (e.g., 0.1 k egos column and 1 k egos column) represent cases where the standard HANA installation outperforms the HANA plus Hipergraph implementation. Notice that for a very small set of egos on the scale of one thousand, the HANA plus Hipergraph implementation does not perform better than the standard HANA installation. However, when needing to provide recommendations for 10 k egos, the HANA plus Hipergraph implementation becomes competitive, and beyond that the HANA plus Hipergraph implementation significantly outperforms the standard HANA installation.

### Comparing Hadoop/Hive with Hipergraph

Another standard approach uses a Hadoop/MapReduce framework as the database. When working with large datasets, a standard architecture may be to use Hadoop to store the data, and then use the MapReduce framework to reason over it. In particular Hive, an application program interface (API) layer that sits on top of Hadoop, interprets SQL-like statements, optimizes the query, and runs the necessary MapReduce programs to compute results. The Hive/Hadoop combination represents another approach for solving this problem. The inventors have implemented and benchmarked such a system using the same datasets.

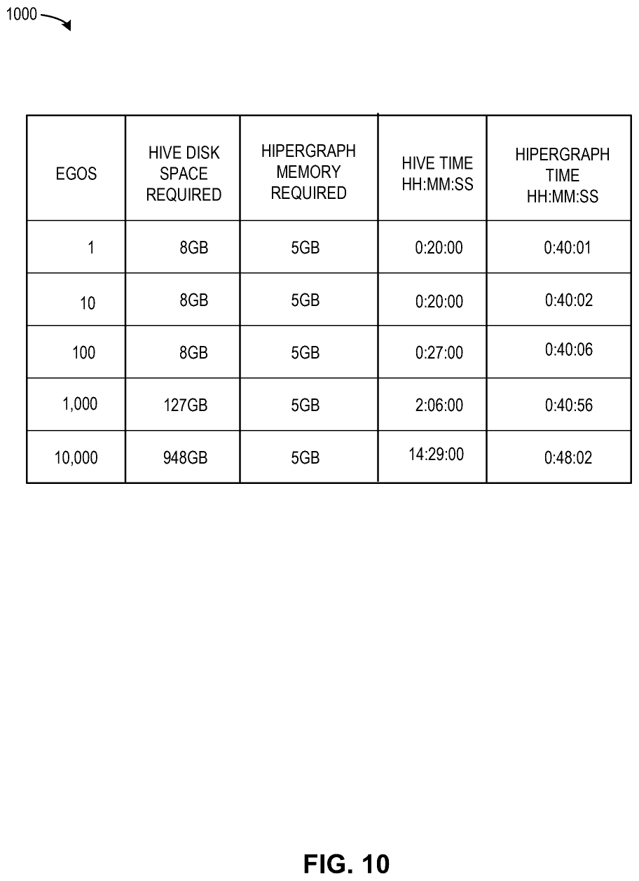

FIG. 10 presents a table 1000 of experimental results comparing implementations of the egocentric collaborative filter on Hadoop/Hive with HiperGraph. FIG. 10 compares the time for Hive/Hadoop to compute recommendations to the time required for HANA/HiperGraph to do the same. For various batch sizes of egos, the inventors measured the amount of time required to finish computing recommendations for that set of egos as well as the amount of memory and disk space required to perform the computations.

There are various points to consider when interpreting these results. Note that the experiment uses the full dataset of hundreds of millions of rows instead of a subset, because it is only for datasets this large that someone skilled in the art would consider using Hive/Hadoop, thereby motivating this experiment. Note also that the experiment directly compares the amount of disk space Hive requires to the amount of memory that HiperGraph requires, because these are the resources that both systems use in order to hold intermediary computations. Thus, this comparison of resource usage is more appropriate for assessing scalability as opposed to a memory-memory comparison (which Hive doesn't leverage), or a disk-disk comparison (which HiperGraph doesn't leverage). Finally, because HiperGraph requires building a graph model but Hive does not, for a fair comparison the HiperGraph results include the graph model building and network transmission times.

Note that for a small number of batch requests, HiperGraph's time is dominated by the graph modeling and network streaming, which is a flat cost of 40:01 for the entire dataset.

### Comparing Time Performance Between Hive and Hipergraph

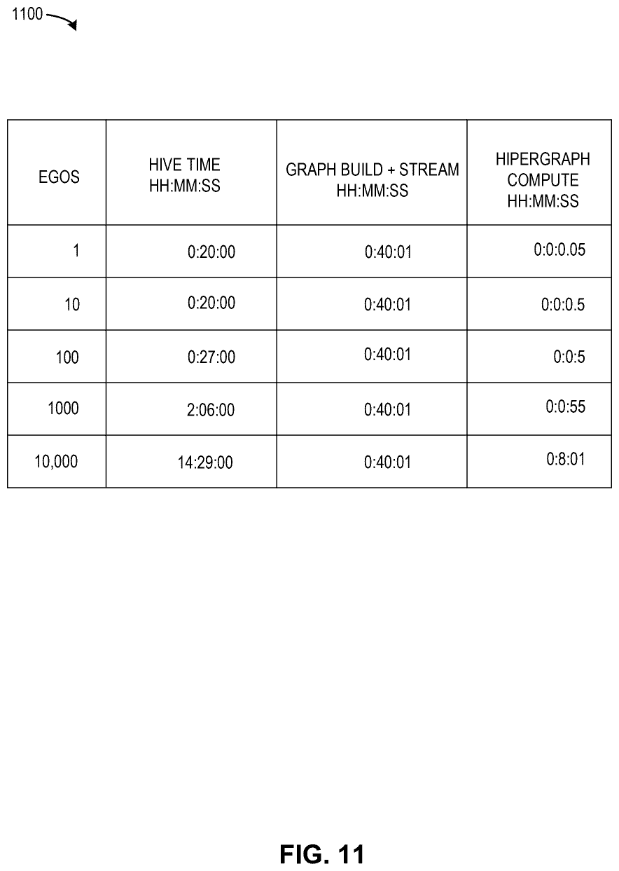

FIG. 11 presents a table 1100 comparing time performance between Hive and HiperGraph, with a breakdown of graph building, streaming, and HiperGraph reasoning. FIG. 11 breaks down HiperGraph's total time into the time required to build and stream the graph and the time to compute over this graph. This one-time, up-front cost pays back significantly when computing a much larger set of recommendations. For 1,000 and 10,000 egos, HiperGraph completes the computation significantly faster than Hive even when counting the time for building and streaming the graph. Recall that at 1,000 and 10,000 egos, the intermediary tables that Hive generates due to the SQL joins increases the required disk space significantly, and for an input dataset that is only a few gigabytes the required disk space approaches one terabyte. HiperGraph, on the other hand, does not suffer from significantly increased storage requirements because the database joins that Hive must perform require negligible memory when performed as graph traversals in HiperGraph. This is why HiperGraph maintains a flat memory requirement for larger and larger sized batches of egos.

Note that Hive attempts to process all egos simultaneously whereas HiperGraph processes them individually in serial (in some embodiments Hipergraph may process the egos in parallel). Although one may say that both Hive and HiperGraph are making tradeoffs between memory/disk required with computation time, the experiments reveal that HiperGraph dominates Hive/Hadoop in this tradeoff game, because HiperGraph has exceeded Hive in both performance and memory/disk efficiency. The inventors performed the experiments in this section with hardware that included Hive/Hadoop running on a 10-server cluster. The SAP HANA SQL database had access to 1 TB of RAM, which was representative of the best-in-class for SQL databases. The server that Hipergraph was running on was a 24-core Intel Xeon 3.33 GHz system with 96 GB of RAM (even though the memory capacity of the hardware was not fully utilized).

### General Template and Mapping Hipergraph Primitives to Relational Primitives

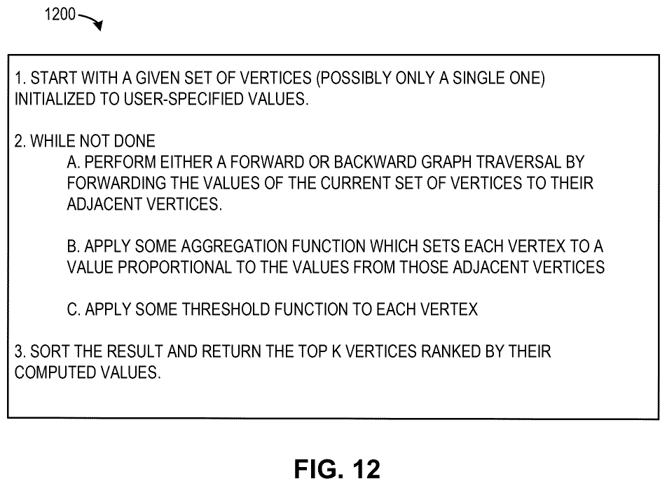

FIG. 12 presents a table illustrating a general template for a class of egocentric collaborative techniques that leverage paragraph primitives, in accordance with an embodiment. As illustrated in FIG. 12, the template includes operations that start with a given set of vertices (possibly only a single one) initialized to user-specified values. While not done, the system may (a) perform either a forward or backward graph traversal by forwarding the values of the current set of vertices to their adjacent vertices, (b) apply some aggregation function which sets each vertex to a value proportional to the values from those adjacent vertices, and (c) apply some threshold function to each vertex. The system may then sort the result and return the top k vertices ranked by their computed values.

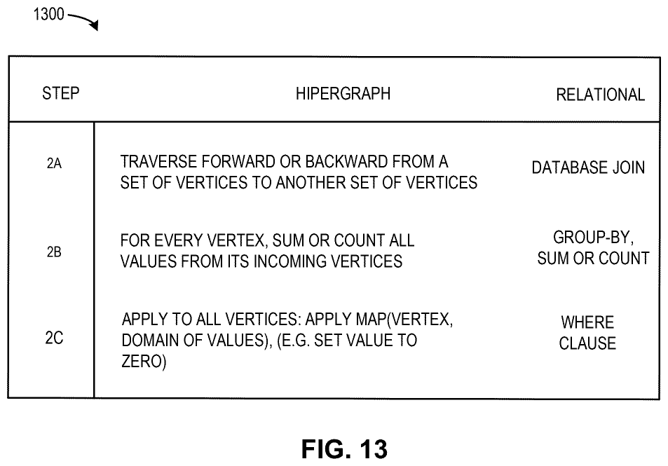

FIG. 13 presents a table illustrating how Hipergraph primitives may map to relational primitives, in accordance with an embodiment. There is evidence from experiments that suggest significant gains in performance in addition to memory/disk space efficiency compared to SQL installations on the same class of techniques. One may be able to achieve the same types of performance gains and memory efficiency for the class of techniques that uses the primitives shown in FIG. 13. The map function offers some flexibility with defining a function to map the vertex value to another set of values.

Although this disclosure uses the multimedia domain for an exemplary implementation, the techniques presented in this disclosure are more general, because vertices and edges in a graph representation map directly to entities and relations in standard database representations. Instead of consumers, media, and accesses, different implementations may have people, places, and event attended. For example, some implementations may use doctors, patients, and medical claims. The collaborative filtering algorithm can apply to various other domains as well.

### Exemplary Apparatus

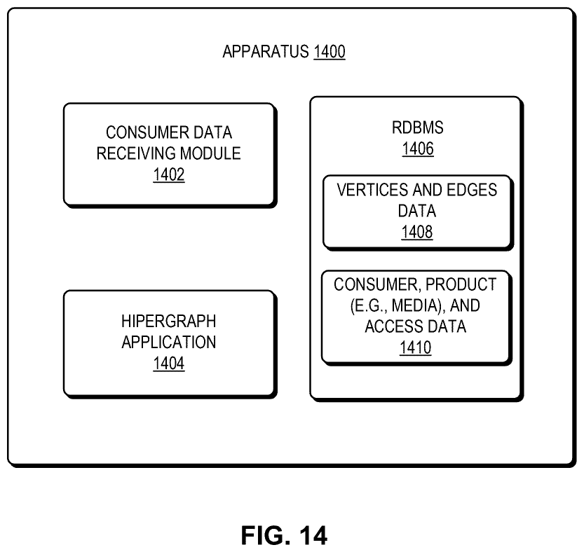

FIG. 14 presents a block diagram illustrating an exemplary apparatus 1400 that facilitates egocentric collaborative filtering, in accordance with an embodiment. Apparatus 1400 can comprise a plurality of modules which may communicate with one another via a wired or wireless communication channel. Apparatus 1400 may be realized using one or more integrated circuits, and may include fewer or more modules than those shown in FIG. 14. Further, apparatus 1400 may be integrated in a computer system, or realized as a separate device which is capable of communicating with other computer systems and/or devices. Specifically, apparatus 1400 can comprise a consumer data receiving module 1402, a Hipergraph application 1404, a RDBMS 1406, vertices and edges data 1408, and consumer, product (e.g., media), and access data 1410. Note that apparatus 1400 may also include additional modules not depicted in FIG. 14.

In some embodiments, consumer data receiving module 1402 can receive consumer, product (e.g., media), and access data. Hipergraph application 1404 may perform operations on a graph to provide a recommendation. RDBMS 1406 may include a storage for storing vertices and edges data 1408 and consumer, product (e.g., media), and access data 1410. RDBMS 1406 may generate the graph based on the consumer, product, and access data.

### Exemplary System

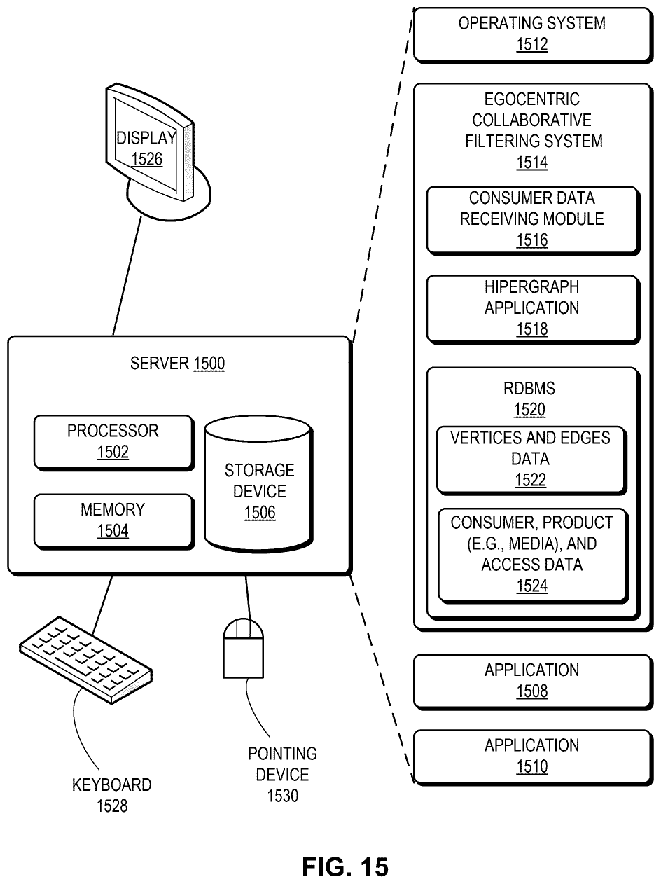

FIG. 15 illustrates an exemplary egocentric collaborative filtering server 1500, in accordance with an embodiment. In one embodiment, server 1500 includes a processor 1502, a memory 1504, and a storage device 1506. Storage device 1506 stores a number of applications, such as applications 1508 and 1510 and operating system 1512. Storage device 1506 also stores egocentric collaborative filtering system 1514 that includes a consumer data receiving module 1516, a Hipergraph application 1518, a RDBMS 1520, vertices and edges data 1522, and consumer, product (e.g., media), and access data 1524. Server 1500 may generate and copy the vertices and edges data 1522 to a memory section accessible to Hipergraph application 1518. During operation, one or more applications, such as egocentric collaborative filtering system 1514, are loaded from storage device 1506 into memory 1504 and then executed by processor 1502. While executing the program, processor 1502 performs the aforementioned functions. System 1500 may be coupled to an optional display 1526, a keyboard 1528, and a pointing device 1530.

In some embodiments, consumer data receiving module 1516 can receive consumer, product (e.g., media), and access data. Hipergraph application 1518 may perform operations on a graph to provide a recommendation. RDBMS 1520 may include a storage for storing vertices and edges data 1522 and consumer, product (e.g., media), and access data 1524. RDBMS 1520 may generate the graph based on the consumer, product, and access data.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-executable method for generating a product recommendation, comprising:
obtaining graph data indicating vertices and edges of a graph, wherein the vertices represent consumers and products and an edge represents an access relationship;
receiving a query to determine a product recommendation, wherein the query indicates an ego for determining a product recommendation;
traversing the graph from a vertex representing the ego through a plurality of edges to a plurality of vertices representing products;
traversing the graph from the plurality of vertices representing products to a plurality of vertices representing other consumers;
traversing the graph from the plurality of vertices representing other consumers to a plurality of vertices representing other products;
generating a recommendation based on the plurality of vertices representing other products.

2. The method of claim 1, further comprising:
generating the graph based on data from one or more database tables; and
streaming the graph data from a SQL database over a network to an executing application.

3. The method of claim 1, further comprising:
receiving command-line parameters indicating a number of starting vertices, a number of recommendations to be generated, a number of traversals, or a number of media that must be shared in common between the ego and another consumer.

4. The method of claim 1, further comprising:
receiving a second query to determine product recommendations for a plurality of egos; and
traversing, by a plurality of processors operating in parallel, the graph from the plurality of egos through a plurality of edges to a plurality of vertices representing products;
traversing, by the plurality of processors operating in parallel, the graph from the plurality of vertices representing products to a plurality of vertices representing other consumers;
traversing, by the plurality of processors operating in parallel, the graph from the plurality of vertices representing other consumers to a plurality of vertices representing other products;
calculating a tally for each of the plurality of vertices representing other products;
sorting the plurality of vertices representing other products; and
generating a recommendation based on the sorted plurality of vertices representing other products.

5. The method of claim 1, wherein the graph has multiple edge types connecting vertices, and one of the edge types represents a like relationship between a respective consumer and a respective product, and wherein the vertex representing the ego and the plurality of vertices representing other consumers are also connected via edges representing like relationships.

6. The method of claim 1, further comprising:
calculating a tally for each of the plurality of vertices representing other products.

7. The method of claim 6, wherein generating the recommendation further comprises:
sorting and ranking the plurality of vertices representing other products; and
generating the recommendation to include one of:
all products associated with the plurality of vertices representing other products and their corresponding tallies;
products with tallies above a predetermined ranking; and
all products and their corresponding tallies, wherein the corresponding tallies are greater than a predetermined user-specified value.

8. A non-transitory computer-readable storage medium storing instructions that when executed by a computer cause the computer to perform a method for generating a product recommendation, the method comprising:
obtaining graph data indicating vertices and edges of a graph, wherein the vertices represent consumers and products and an edge represents an access relationship;
receiving a query to determine a product recommendation, wherein the query indicates an ego for determining a product recommendation;
traversing the graph from a vertex representing the ego through a plurality of edges to a plurality of vertices representing products;
traversing the graph from the plurality of vertices representing products to a plurality of vertices representing other consumers;
traversing the graph from the plurality of vertices representing other consumers to a plurality of vertices representing other products;
generating a recommendation based on the plurality of vertices representing other products.

9. The computer-readable storage medium of claim 8, wherein the method further comprises:
generating the graph based on data from one or more database tables; and
streaming the graph data from a SQL database over a network to an executing application.

10. The non-transitory computer-readable storage medium of claim 8, wherein the method further comprises:
receiving command-line parameters indicating a number of starting vertices, a number of recommendations to be generated, a number of traversals, or a number of media that must be shared in common between the ego and another consumer.

11. The non-transitory computer-readable storage medium of claim 8, wherein the method further comprises:

3. receiving a second query to determine product recommendations for a plurality of egos; and
traversing, by a plurality of processors operating in parallel, the graph from the plurality of egos through a plurality of edges to a plurality of vertices representing products;
traversing, by the plurality of processors operating in parallel, the graph from the plurality of vertices representing products to a plurality of vertices representing other consumers;
traversing, by the plurality of processors operating in parallel, the graph from the plurality of vertices representing other consumers to a plurality of vertices representing other products;
calculating a tally for each of the plurality of vertices representing other products;
sorting the plurality of vertices representing other products; and
generating a recommendation based on the sorted plurality of vertices.

12. The non-transitory computer-readable storage medium of claim 8, wherein the graph has multiple edge types connecting vertices, and one of the edge types represents a like relationship between a respective consumer and a respective product, and wherein the vertex representing the ego and the plurality of vertices representing other consumers are also connected via edges representing like relationships.

13. The non-transitory computer-readable storage medium of claim 8, wherein the method further comprises:
calculating a tally for each of the plurality of vertices representing other products.

14. The non-transitory computer-readable storage medium of claim 13, wherein generating the recommendation further comprises:
sorting and ranking the plurality of vertices representing other products; and
generating the recommendation to include one of:
all products associated with the plurality of vertices representing other products and their corresponding tallies;
products with tallies above a predetermined ranking; and
all products and their corresponding tallies, wherein the corresponding tallies are greater than a predetermined user-specified value.

15. A computing system for generating a product recommendation, the system comprising:
one or more processors,
a non-transitory computer-readable medium coupled to the one or more processors having instructions stored thereon that, when executed by the one or more processors, cause the one or more processors to perform a method for generating a product recommendation, the method comprising:
obtaining graph data indicating vertices and edges of a graph, wherein the vertices represent consumers and products and an edge represents an access relationship;
receiving a query to determine a product recommendation, wherein the query indicates an ego for determining a product recommendation;
traversing the graph from a vertex representing the ego through a plurality of edges to a plurality of vertices representing products;
traversing the graph from the plurality of vertices representing products to a plurality of vertices representing other consumers;
traversing the graph from the plurality of vertices representing other consumers to a plurality of vertices representing other products;
generating a recommendation based on the plurality of vertices representing other products.

16. The computing system of claim 15, wherein the method further comprises:
generating the graph based on data from one or more database tables; and
streaming the graph data from a SQL database over a network to an executing application.

17. The computing system of claim 15, wherein the method further comprises:
receiving command-line parameters indicating a number of starting vertices, a number of recommendations to be generated, a number of traversals, or a number of media that must be shared in common between the ego and another consumer.

18. The computing system of claim 15, wherein the method further comprises:
receiving a second query to determine product recommendations for a plurality of egos; and
traversing, by a plurality of processors operating in parallel, the graph from the plurality of egos through a plurality of edges to a plurality of vertices representing products;
traversing, by the plurality of processors operating in parallel, the graph from the plurality of vertices representing products to a plurality of vertices representing other consumers;
traversing, by the plurality of processors operating in parallel, the graph from the plurality of vertices representing other consumers to a plurality of vertices representing other products;
calculating a tally for each of the plurality of vertices representing other products;
sorting the plurality of vertices representing other products; and
generating a recommendation based on the sorted plurality of vertices representing other products.

19. The computing system of claim 15, wherein the graph has multiple edge types connecting vertices, and one of the edge types represents a like relationship between a respective consumer and a respective product, and wherein the vertex representing the ego and the plurality of vertices representing other consumers are also connected via edges representing like relationships.

20. The computing system of claim 15, wherein the method further comprises:
calculating a tally for each of the plurality of vertices representing other products.
